(19) United States
(12) Patent Application Publication
(10) Pub. No.: US 2009/0007452 A1
(43) Pub. Date: Jan. 8, 2009

(54) Drying unit Using far Infrared Rays, Drying Apparatus Using the Unit and Waveguide for the Apparatus

(76) Inventor: Kuk Rae Cho, Kyungnam (KR)

Correspondence Address: THE NATH LAW GROUP, 112 South West Street, Alexandria, VA, 22314, US

(21) Appl. No.: 11/629,309

(22) PCT Filed: Jun. 14, 2005
(86) PCT No.: PCT/KR05/01799

§ 371 Date: Aug. 25, 2008

(30) Foreign Application Priority Data
Jun. 14, 2004 (KR) 10-2004-0043553

(51) Int. Cl. F26B 3/34

(52) U.S. Cl. 34/265

(57) ABSTRACT

Disclosed is a far infrared drying apparatus, including: at least one far infrared drying unit, which is heated by an electric heating element and converts heat energy into far infrared rays, namely, electromagnetic wave energy: a support name for supporting the at least one far infrared driving unit; a moving device for moving the support frame; and a waveguide for guiding the far infrared rays over a long distance onto an object to be dried.

### TECHNICAL FIELD

The present invention relates in general to a drying apparatus using far infrared ray, and more particularly to a drying apparatus using far infrared and a drying unit using far infrared ray featuring low power consumption and improved drying efficiency, by emitting far infrared rays at high efficiency and guiding far infrared rays to an object to be dried even over a long distance. Also, the present invention relates to a foil or plate-shaped waveguide for far infrared guidance, which is made of vacuum-deposited metal fiber or fiber with a thin metal plate being attached to one side or both sides thereof.

### BACKGROUND ART

In general, ship block, marine structures, and other large steel structures are painted a lot to maintain their performance and durability. In fact, the quality of the painting is very important because it is directly related to the lifespan of a ship or a structure. Drying process of the paint is much important as a determining factor of the painting quality.

Natural drying outdoors requires warm days and low humidity. Therefore, the printing work cannot be done during cold weather, i.e., the outside temperature falling below 5° C., or during rainy weather of high humidity because the bad weather conditions often deteriorate the painting quality. If bad weather continues for an extended period of time, the amount of painting days is automatically limited and the entire work procedure is affected thereby, causing a delay in production.

Even though the conventional large-scale drying system is usually equipped with a hot-air blowing device, its installation cost is very high and a tremendous amount of energy is required to keep the large space at high temperature.

As an attempt to solve these problems, a far infrared ray heating appliance was developed. Although the far infrared ray heating appliance was advantageous in that the drying process of painting could be done independent of weather conditions, the radiation distance of far infrared rays was as short as 0.7 m. Thus, drying a large structure such as a ship block could not be done effectively. Also, the conventional far infrared heater had problems, for example, the heat efficiency at an electromagnetic wave converting region was often reduced due to the air convection and thus, the amount of electromagnetic radiation was rather small.

### DISCLOSURE OF INVENTION

### Technical Problem

Therefore, the present invention has been made in view of the above problems, and it is an object of the present invention to provide a drying apparatus using far infrared and a drying unit for creating a large-scale drying area for the painting job both indoors and outdoors, irrespective of cold and/or humid weather, by radiating electromagnetic waves of a far infrared region over a long distance.

It is another object of the present invention to provide a waveguide made of vacuum-deposited metal fiber or fiber with a metal thin film being attached to one side or both sides thereof, capable of preventing the deviation of far infrared radiation and guiding far infrared rays over a long distance farther than 50 m for example.

### Technical Solution

in accordance with an aspect of the present invention, the above objects can be accomplished by the provision of a far infrared drying apparatus, comprising: at least one far infrared drying unit, which is heated by an electric heating element and converts heat energy into far infrared rays, namely, electromagnetic wave energy; a support frame for supporting the at least one far infrared drying unit; a moving device for moving the support frame; and a waveguide for guiding the far infrared rays over a long distance onto an object to be dried. The drying unit features a higher heating efficiency than a conventional far infrared heater, thereby considerably improving the heat efficiency and the far infrared radiation efficiency.

The frame moving device can move the frame using a rail and a driving motor, while being supported by a building pillar for instance, or along the rail on the ground below.

The waveguide according to the present invention is a device for guiding far infrared rays generated from the far infrared drying unit over a long distance. The waveguide is made of a large-scale of metal vacuum-deposited fiber or a large-scale fiber with a thin metal plate being attached to one side or both sides thereof. As such, the waveguide can be applied to a large drying area. And, if necessary, the waveguide can be wound also. A conventional waveguide was a small-sized waveguide made of metallic materials and used exclusively for the transmission of electromagnetic waves.

Meanwhile, any kind of fiber can be used for metal vacuum deposition. Examples of the fiber include natural fibers such as cotton and hemp, synthetic fibers such as rayon, acetate, polyamide (nylon), polyester, acryl, polyurethane, carbon fiber, glass fiber, and Teflon, and finished/processed fibers such as a non-woven fiber. To minimize the risk of fire, any inflammable fibers go through the flame retardant treatment.

The metal for use in metal vacuum deposition should have high far infrared reflectivity. Preferable examples of such metal include silver and aluminum. At this time, any well-known metal vacuum deposition method in the art can be used.

The fiber with a thin metal plate being attached to one side or both sides thereof is prepared by adhering a thin metal plate onto one side or both sides of the fiber through a heat resistant adhesive. The same fibers used in the metal vacuum deposition are used here.

Particularly, the metal used in the thin metal plate should have high electromagnetic wave reflectivity, such as, silver, copper, aluminum or stainless steel. Preferably, the thin metal plate is 1-1000 in thickness.

### ADVANTAGEOUS EFFECTS

By utilizing the waveguide, the radiation distance of the far infrared rays (i.e., the electromagnetic wave energy) converted at the far infrared drying unit can be extended from 70 cm conventional up to 50 m or more. Also, by keeping the surrounding temperature of the far infrared converter at 200-500° C., the energy efficiency can be improved markedly. In this manner, the heat loss of the far infrared converter, which is the main cause of reduction in the generation rate of far infrared rays, due to the convection of heated air in the drying space, i.e., outdoors, conveyor tunnel or box-typed drying space, can be reduced very effectively.

Since the drying apparatus has a movable structure, the drying space can be used more efficiently.

In addition, the far infrared drying apparatus can improve the painting quality and further, the polishing effect. The far infrared drying apparatus of the present invention is also advantageous in that a high-quality painting can be done irrespective of weather conditions including cold weather or humid/rainy weather.

Also, the painting job and the drying process can be facilitated by moving the far infrared drying apparatus to any desired direction. Lastly, the far infrared drying unit(s) of the apparatus is well protected from a great amount of dust produced during the painting job.

### BEST MODE FOR CARRYING OUT THE INVENTION

A far infrared drying apparatus of the present invention includes: a far infrared drying apparatus, including: at least one far infrared drying unit, which is heated by an electroheating element and converts heat energy into far infrared rays, namely, electromagnetic wave energy; a support frame for supporting the at least one far infrared drying unit; a moving device for moving the support frame; and a waveguide for guiding the far infrared rays over a long distance onto an object to be dried. The drying unit features a higher heating efficiency than a conventional far infrared heater, and the waveguide has extended the far infrared radiation distance from 70 cm, the maximum far infrared radiation distance of a reflective mirror used in the conventional far infrared heater, to 50 m or more. Furthermore, by preventing any loss of electromagnetic waves and guiding the far infrared rays onto a target object only, the drying efficiency was enhanced markedly.

The above and other objects, features and other advantages of the present invention will be more clearly understood from the following detailed description taken in conjunction with the accompanying drawings, in which:

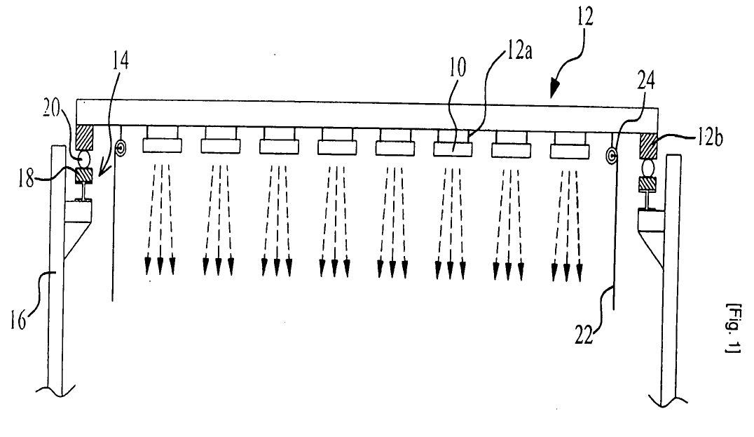

FIG. 1 is a conceptual diagram of a lateral view of a far infrared drying apparatus according to the present invention;

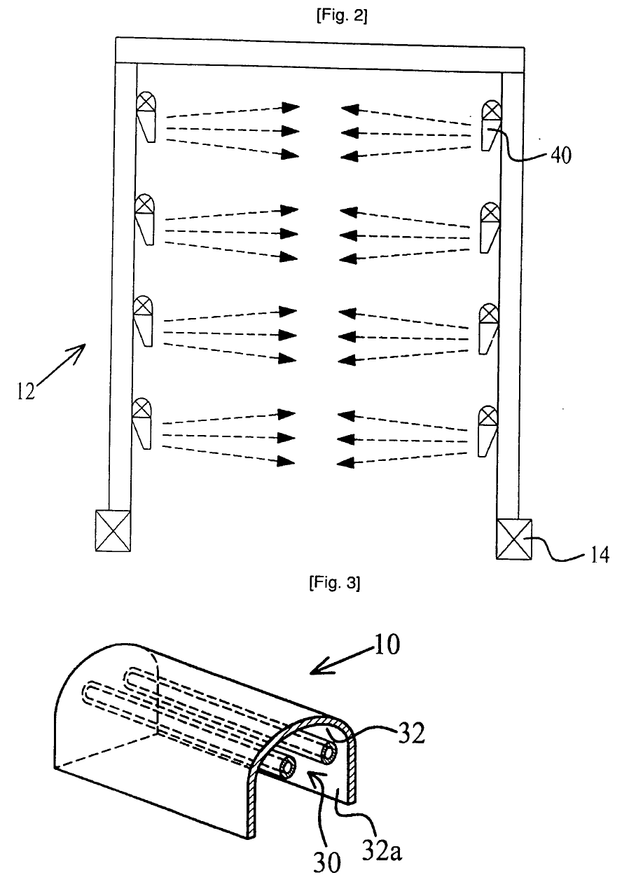

FIG. 2 is a side view of a far infrared drying apparatus according to the present invention;

FIG. 3 is a schematic view of a far infrared drying unit for use in the far infrared drying apparatus of FIG. 1;

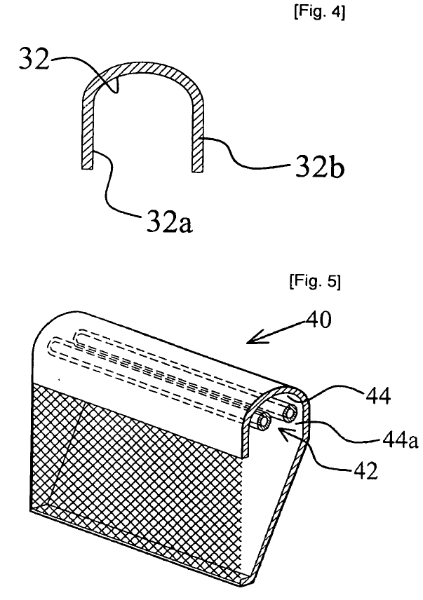

FIG. 4 is a partial cross-sectional view of a reflective mirror for use in the drying unit and a waveguide extended therefrom;

FIG. 5 is a schematic view of a far infrared drying unit for use in the far infrared drying apparatus of FIG. 2;

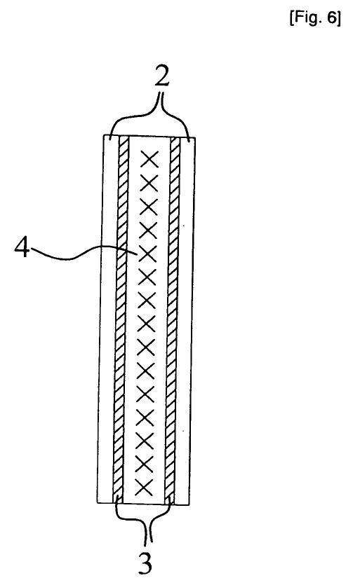

FIG. 6 is a cross-sectional view of a waveguide for use in a far infrared drying apparatus according to the present invention, in which the waveguide is made of a fiber having metal thin films being attached to both side surfaces of the waveguide; and

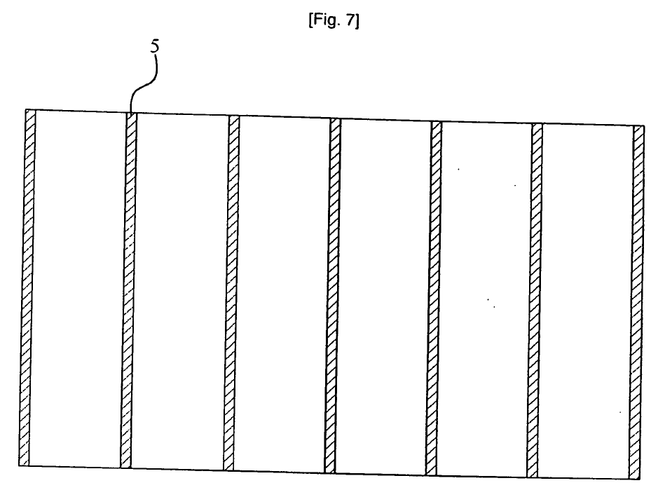

FIG. 7 illustrates another embodiment of a waveguide according to the present invention, in which bands are attached to the waveguide at regular intervals.

### MODE FOR THE INVENTION

Preferred embodiments of the present invention will now be described in detail with reference to the accompanying drawings.

FIG. 1 is a conceptual diagram of a lateral view of a far infrared drying apparatus according to the present invention. Referring to FIG. 1, the far infrared drying apparatus includes at least one far infrared drying unit 10 being aligned, each converting heat energy into far infrared rays (i.e., electromagnetic wave energy); a support frame 12 for supporting the drying units 10; and a moving device 14 for moving the support frame 12. The support frame 12 is provided with drying unit securing parts 12a and lower frames 12b. The securing part 12a secures each of the far infrared drying unit 10 and is supported by the support frame 12. In case that a plurality of far infrared drying units 10 are needed for a large-area drying apparatus, the lower frames 12b are installed in the longitudinal direction along the movement direction of the drying units.

In general, the painting job produces a great amount of dust. Therefore, to protect the far infrared drying units 10 from the dust, it is necessary to move the drying apparatus away in the horizontal direction, or move the drying units away to a pre-determined place for conveniently drying a certain area of the drying apparatus. The moving device 14 is installed to meet these needs. For instance, the moving device 14 includes a motor and wheels 20 that move on a rail 18 being supported by a separate structure 16 such as a pillar or the wall of a building. The moving device 14 is installed at sides, lower portion or upper portion of the support frame.

To see how the far infrared drying unit 10 operates, far infrared rays having been converted inside a concave reflective mirror which encompasses the drying unit are reflected from the mirror, and guided by a waveguide (to be described), thereby drying an object to be dried below at high efficiency.

The waveguide 22 is suspended from the support frame 12 in such a manner that it can radiate far infrared rays very effectively onto the object to be dried. That is to say, the waveguide 22 makes sure that the far infrared rays having been converted at each of the drying unit 10 do not escape and disperse to the outside but are guided to the object to be dried inside the drying apparatus. Preferably, the waveguide 22 is installed on the front and rear surfaces of the drying apparatus, along each side, or at least one side of the drying apparatus. The waveguide 22 is made of far infrared reflecting materials. For instance, an aluminum foil is attached to a textile material or a non-woven fabric in form of a curtain. In this manner, it becomes easier to adjust the height of the waveguide 22. Preferably, an adjusting device 24 for adjusting the height of the waveguide 22 is provided, so that the far infrared radiation can be adjusted by the size or height of the object to be dried. An example of the adjusting device 24 is a roller or a motor. The adjusting device 24 may be installed below the waveguide 22.

The height-adjustable waveguide 22 is effective for radiating far infrared rays over a substantially long distance.

FIG. 2 shows a far infrared drying apparatus according to another embodiment of the present invention, in which far infrared drying units 40 are installed at both sides and an object to be dried in the middle of the drying units 40. Similar to the above embodiment, the far infrared drying units 40 are supported by a support frame 12. However, in this particular embodiment, the support frame 12 is arranged on both sides of the drying apparatus as shown in FIG. 2 to support the drying units 40 in a vertical direction. Although not shown, a waveguide can be installed on the outside of the drying units 40.

In addition, a moving device 14 for moving the drying apparatus may be installed at a lower portion of the support frame 12. In effect, the moving device 14 can be installed at an upper portion or side thereof. Similar to the first embodiment, the moving device 14 can be installed in form of a crane attached to the ceiling. Also, the support frame 12 is preferably provided with insulating layers. As in the first embodiment, the moving device 14 is formed of wheels, a rail, and a motor.

The far infrared drying units 40 dry the object located inside the drying apparatus very effectively, by using far infrared rays that are generated and reflected from a concave reflective mirror.

To enhance the drying efficiency, a waveguide (not shown) can also be utilized. Namely, by adjusting the height of the waveguide, far infrared rays can be very effectively guided and radiated onto the object to be dried. Preferably, the waveguide is installed on the front and rear surfaces of the drying apparatus, along each side, or at least one side of the drying apparatus. Here, the waveguide is made of far infrared reflecting materials, and is equipped with an adjusting device for adjusting the height of the waveguide, so that the far infrared radiation can be adjusted by the size or height of the object to be dried. An example of the adjusting device is a roller or a motor.

In case that a fixed-type (or immobile) drying apparatus is used, a metal-plate waveguide can be used.

FIG. 3 is a schematic view of the far infrared drying unit 10 for use in the far infrared drying apparatus of FIG. 1, and FIG. 4 is a partial cross-sectional view of a reflective mirror for use in the drying unit and a waveguide extended perpendicularly therefrom. Each of the far infrared drying unit 10 includes at least one far infrared converter 30 for converting heat energy of an electric heating element into electromagnetic wave energy. The far infrared rays from the far infrared converter 30 are guided by (to be more specific, reflected from) a reflective mirror 32 on the upper portion of the drying unit 10 towards an object to be dried. Here, to increase the far infrared generation rate, the reflective mirror 32 is preferably in a concave shape. That is, the curved portion of the reflective mirror 32 is extended downwards or in the perpendicular direction, and forms a waveguide 32a that creates a layer of heated air for getting hot air. The waveguide 32a extended downwards or in the perpendicular direction from the reflective mirror 32 prevents heated air from being convected and far infrared rays from scattering to the outside and guides them onto the object to be dried. At the same time, the waveguide 32a is installed in such a manner that it encompasses the far infrared converter 30. In consequence, the far infrared converter 30 is not easily cooled down by the convection of air having a lower temperature than the surrounding temperature of the converter 30, and the heat efficiency is increased markedly. Meanwhile, an insulating layer 32b is formed on the outside of the reflective mirror 32 and the waveguide 32a.

FIG. 5 is a schematic view of the far infrared drying unit for use in the far infrared drying apparatus according to the embodiment (refer to FIG. 2) of the present invention. The far infrared drying unit 40 includes at least one far infrared converter 42 inside, similar to the one shown in FIG. 3. The far infrared rays from the far infrared converter 42 are guided by a reflective mirror 44 on the upper portion of the drying unit 40 towards an object to be dried. Here, to increase the far infrared generation rate, the reflective mirror 44 is preferably in a concave shape. That is, the curved portion of the reflective mirror 44 is extended downwards or in the perpendicular direction, and forms a waveguide 44a that creates a layer of heated air for getting hot air. The waveguide 44a extended downwards or in the perpendicular direction from the reflective mirror 44 prevents far infrared rays from dispersing to the outside and guides them onto the object to be dried. At the same time, the waveguide 44a is installed in such a manner that it encompasses the far infrared converter 42. As a result, the heat of the far infrared converter 42 is not easily lost by the air convection, and the heat efficiency is increased markedly.

Meanwhile, in case of a heating/drying equipment in a conventional conveyor type or box type, a fixed metal-plate waveguide is used.

FIG. 6 is a cross-sectional view of a waveguide for use in a drying unit, in which the waveguide is capable of guiding far infrared rays over a long distance and simultaneously, onto a painted portion only. In particular, FIG. 6 is a conceptual cross-sectional view illustrating a waveguide made of thin metal plates deposited over both sides of a cloth. The double-side cloth is prepared by applying a heat resistant adhesive 3 to a thin metal plate 2 selected from metals having a high electromagnetic reflectivity such as silver, copper, aluminum and SUS, and to a fiber 4 selected from non-flammable fibers such as carbon fiber and glass fiber; and depositing the thin metal plate 4 on both side surfaces of the fiber 4. By encompassing the drying apparatus with the prepared waveguide, it becomes possible to increase the far infrared radiation distance considerably. As such, the drying apparatus can be advantageously used for a large-scale drying area, and even a large-scale object can be dried within a short period of time.

FIG. 7 illustrates another embodiment of a waveguide according to the present invention, in which bands 5 are attached to the waveguide at regular intervals so as to protect the waveguide from repetitive winding. Here, the bands 5 are made of fiber or leather. Optionally, the bands 5 can be made of polypropylene (PP) cloth of high toughness. In case of using a fixed type (immobile) drying apparatus, a metal plate waveguide can be used.

By applying this type of waveguide to the far infrared drying apparatus, the far infrared radiation distance can be extended over several meters to several tens of meters. This means that even a large-scale object can be dried very easily within a short period of time.

In other words, although the conventional drying apparatus without the waveguide could provide a drying space as big as several tens of cubic meters only, the drying apparatus with the waveguide of the present invention is able to expand the drying space up to several thousands of cubic meters or more by guiding far infrared rays over a long distance, showing a noticeable increase in the drying range.

In addition, since the far infrared energy is guide and radiated only on a printed portion to be heated/dried, the energy efficiency can be maximized.

### INDUSTRIAL APPLICABILITY

Therefore, the drying process that used to be performed on small painted items only can now be applied to a large-scale block, irrespective the kind and amount of objects to be dried.

Moreover, in case that the present invention is utilized for a fixed drying equipment such as a heat treatment booth handling a painted automobile body in a car repair shop, its energy saving effect is much larger than conventional far infrared equipments.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A far infrared drying unit, comprising:
a far infrared converter heated by an electric heating element for converting electric energy into far infrared rays;
a inwardly curved reflective mirror being arranged in such a manner to encompass the far infrared converter to prevent heat loss due to the air convection and form a heated air layer, and guiding an electromagnetic wave towards an object;
a metal-plate waveguide suspended from the reflective mirror in a vertically downward direction for preventing heat loss due to the air convection and guiding the far infrared rays over a long distance; and
an insulating layer coated on the reflective mirror and the waveguide that encompass the heated air layer.

2. A far infrared drying apparatus, comprising:
at least one far infrared drying unit according to claim 1, which is heated by an electric heating element and radiates far infrared rays onto an object to be dried; and
a support frame for supporting the at least one far infrared drying unit.

3. The apparatus according to claim 2, further comprising:
at least one waveguide installed in a circumferential portion of the drying apparatus, each waveguide being fiber coated with a metal layer or being fixed in form of a metal plate so as to radiate the far infrared rays evenly onto the object to be dried by adjusting the radiation distance and direction of the far infrared rays.

4. A waveguide suitable for use in the apparatus of claim 2, wherein the waveguide is made of a metal deposited fiber or a fiber with thin metal plates being adhered to one side or both sides thereof, and used for preventing the dispersion of the far infrared rays and guiding the far infrared rays over a long distance.

5. The waveguide according to claim 4, wherein the metal is selected from a group consisting of silver, copper, aluminum and stainless steel.

6. The waveguide according to claim 4 or claim 5, wherein the fiber is selected from a group consisting of cotton, hemp, rayon, acetate, polyamide, polyester, acryl, polyurethane, carbon fiber, glass fiber, Teflon, and non-woven fiber, and, if necessary, is prepared by performing a flame retardant treatment on a fiber.

7. The waveguide according to claim 4 or claim 5, further comprising:
bands made of fiber or leather with a higher tensile strength than the fiber, for reinforcing the fiber.

8. The waveguide according to claim 4 or claim 5, further comprising:
a winding device composed of a motor and a roller, being installed on the upper end or the lower end of the waveguide for winding the waveguide.
